(19) United States
(12) Patent Application Publication
(10) Pub. No.: US 2026/0180997 A1
(43) Pub. Date: Jun. 25, 2026

(54) MULTIPLE SECURITY FRAMEWORKS ALIGNMENT AND RISK OVERVIEW SYSTEM

(71) Applicant: ORACLE INTERNATIONAL CORPORATION, Redwood Shores, CA (US)

(72) Inventors: Anton BOUGAEV, La Jolla, CA (US); Constantine Lefteri TSOUKALAS, San Diego, CA (US); Shawn Christopher JACKSON, Sacramento, CA (US)

(21) Appl. No.: 18/999,767

(22) Filed: Dec. 23, 2024

(51) Int. Cl. H04L 9/40; H04L 41/16

(52) U.S. Cl. CPC H04L 63/1416; H04L 41/16

(57) ABSTRACT

Systems, methods, and other embodiments associated with providing an overview of alignment and risk when applying multiple security frameworks are described. In one embodiment, a method includes accessing (1) a target entity and (2) a control framework having a plurality of controls. The method includes embedding the target entity and the plurality of controls. The method includes quantifying similarities between the embedded target entity and the plurality of embedded controls. The method includes providing the similarities as multivariate input to a regression model that is configured to generate probabilities that individual controls of the plurality are relevant to the target entity. The method includes applying a threshold for relevance to the probabilities to extract a listing of relevant controls that are most relevant to the target entity. And, the method includes generating an electronic alert that includes the listing of relevant controls.

### BACKGROUND

Large IT enterprises may have multiple set of policies, standards, or requirements that are pertinent to various subject domains, and which may vary by geopolitical territory. The continuously evolving and expanding technology risk universe adds yet another dimension of complexity: existing security catalogs cannot remain static and are instead compelled to adapt to and expand with technological leaps to address emerging cybersecurity threats. AI and quantum computing are currently emerging examples, and large-scale cloud computing is a near-past and presently evolving example.

The above factors, among others, drive a rapid, combinatorial explosion of the number of security controls, systems, policies and other cybersecurity entities that renders human-performed analytics for conformance assurance impracticable. The number of security control frameworks necessary to operate a large and mission-and life-critical complex infrastructures and their interrelations continues to grow rapidly beyond human capacity to remember, comprehend, and determine compliance with.

### Copyright Notice

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a control analysis system that is associated with providing an overview of alignment and risk when applying multiple security frameworks.

FIG. 2 illustrates one embodiment of a control analysis method that is associated with providing an overview of alignment and risk when applying multiple security frameworks.

FIG. 3 illustrates one example security control that is associated with providing an overview of alignment and risk when applying multiple security frameworks.

FIG. 4 illustrates a simplified example DB schema for a DB that is associated with providing an overview of alignment and risk when applying multiple security frameworks.

FIG. 5 illustrates one embodiment of a control analysis (FAROS) system diagram 500 that is associated with providing an overview of alignment and risk when applying multiple security frameworks.

FIG. 6 illustrates a diagram of an example representation of entities in multidimensional space that is associated with providing an overview of alignment and risk when applying multiple security frameworks.

FIG. 7 illustrates a diagram of similarity scoring the control analysis engine 535 that is associated with providing an overview of alignment and risk when applying multiple security frameworks.

FIG. 8 illustrates an example flow of controlled entity characterization that is associated with providing an overview of alignment and risk when applying multiple security frameworks.

FIG. 9 illustrates one example of relevance score fingerprinting of a plurality of controlled entities being used for gap and duplication detection that is associated with providing an overview of alignment and risk when applying multiple security frameworks.

FIG. 10 illustrates an embodiment of a computing system configured with the example systems and/or methods disclosed.

### DETAILED DESCRIPTION

Systems, methods, and other embodiments are described herein that automatically provide an overview of alignment and risk when applying multiple security frameworks. In one embodiment, a control analysis system employs natural language processing (NLP) and recommender systems (RS) to determine an extent of gaps and/or overlap of security control coverage between a plurality of natural language security control frameworks. For example, the control analysis system ingests the security control catalogs and controlled entities (CEs) and then characterizes the CEs with sets of relevant security controls and their associated relevance scores. The control analysis system may thus characterize one security framework with respect to another security farmwork to identify the duplications and the gaps in the conformance assurance coverage. The control analysis system provides security-control-driven derisking and streamlining of cybersecurity assurance.

In one example embodiment, a control analysis system accepts a target entity against which the controls in a control framework are to be assessed for relevance. The target entity and controls are expressed in natural language, and so the control analysis system transforms the target entity and controls into multidimensional embeddings using a pre-trained embedding model. The control analysis system uses the embeddings to quantify similarity between the target entity and the various controls. From these similarities, the control analysis system generates probabilities as to whether individual controls are relevant to the target entity using a regression model configured to perform that task. By applying a threshold on the probabilities to the controls, the control analysis system can identify and extract those of the controls that are most relevant to the target entity, ultimately producing an electronic alert that highlights these most relevant controls.

In one embodiment, the control analysis system improves the accuracy of AI determinations of relevance of security controls to an entity by using linguistic similarity of the entity to a plurality of controls to inform the determination of relevance for individual controls, as shown and described herein.

### Definitions

As used herein, the term “security control” (abbreviated “SC”) refers to individual cybersecurity policies, standards, requirements, safeguards, mechanisms, or other countermeasures configured to mitigate cybersecurity risks to natural and technical systems with material and non-material assets.

As used herein, the term “controlled entity” (abbreviated “CE”) refers to systems, networks, applications, devices, policies, processes, design patterns, organizations, and other distinct parts of larger structures or systems that are subject to one or more security controls established to mitigate cybersecurity risks.

As used herein, the term “target entity” refers to an entity such as a controlled entity or a security control that is under consideration for relevance to one or more controls (such as security controls).

As used herein, the term “security framework” (abbreviated “SF”) refers to a set or “catalog” of definitions of SCs for mitigation of cybersecurity risks. A security framework may include definitions for a plurality of security controls. For example, a security framework may consist of hundreds or thousands of definitions for SCs, which may be further divided into groups of families. The security framework may be written in natural language. National Institute of Standards and Technology (NIST) 800-53 and NIST-800-171 are examples of security frameworks mandated in the United States.

As used herein, the term “conformance assurance” refers to a process of verifying that controlled entities comply with specific security controls by demonstrating that the controlled entities satisfy established benchmarks that indicate that security controls are properly implemented and effective.

As used herein, the term “real-time” refers to the performance of computing actions with a latency or delay that is small enough to appear nearly immediate to a user. In the context of the control analyses described herein, for example, a delay or latency under a few seconds or even a few minutes may be considered to be real-time.

As used herein when describing a relationship between two entities (such as a target entity and a control), the term “relevance” refers to the degree to which one entity (e.g., a control) is applicable, suitable, or meaningful in relation to the other entity (e.g., a target entity). For example, relevance measures the significance of the connection or the impact that a control has concerning the specific needs, requirements, or characteristics of the target entity. A control is considered to be relevant where its associated relevancy score exceeds a pre-specified threshold, and is thereby deemed to have a significant degree of applicability to the target entity.

As used herein, the term “natural language” or NL refers to language used for communication among people, including written text or spoken dictation that is used to express controls (such as security controls), target entities (such as controlled entities). Natural language includes, but is not limited to, written and typewritten forms of text that are converted into electronic data, spoken dictation that is received by a computing device and converted into electronic data, and text extracted from spoken dictation using voice-to-text conversion and/or speech recognition technology. An item of electronic data (such as a security control) is “in natural language” where the electronic data expresses, records, defines, stores, or otherwise represents textual (written) or vocal (spoken) human language.

As used herein, the term “overview of alignment and risk” refers to a regulatory or conformance assurance activity performed by automated systems.

No action or function described or claimed herein is performed by the human mind. An interpretation that any action or function can be performed in the human mind is inconsistent with and contrary to this disclosure.

### Example Control Analysis System

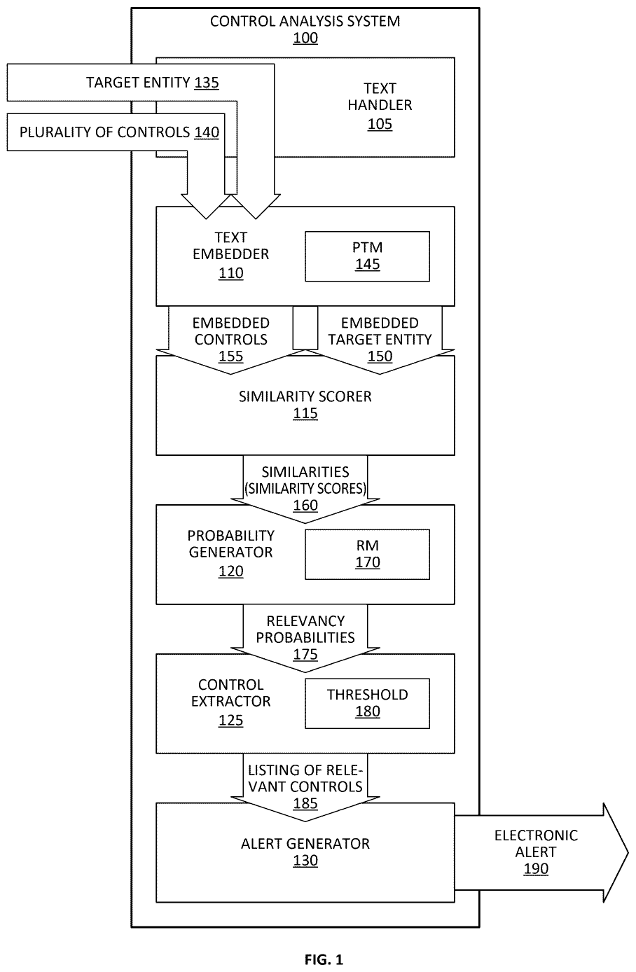

FIG. 1 illustrates one embodiment of a control analysis system 100 that is associated with providing an overview of alignment and risk when applying multiple security frameworks. In one embodiment, control analysis system 100 operates to automatically determine which controls of a control framework are relevant to a target entity. Control analysis system 100 has various components, including a text handler 105, a text embedder 110, a similarity scorer 115, a probability generator 120, a control extractor 125, and an alert generator 130. In one embodiment, the components of control analysis system 100 intercommunicate in a network computing system, for example by electronic messages, as discussed below under the heading “Cloud or Enterprise Embodiments.”

In one embodiment, text handler 105 is configured to access a target entity 135 and a control framework that includes a plurality of controls 140. The target entity 135 and the plurality of controls 140 are expressed in natural language. In one embodiment, text embedder 110 is configured to embed the target entity 135 and the plurality of controls 140 into a multidimensional space using a pre-trained embedding model (PTM) 145, thereby producing an embedded target entity 150 and a plurality of embedded controls 155. In one embodiment, similarity scorer 115 is configured to quantify similarities 160 between the embedded target entity 150 and the plurality of embedded controls 155. In one embodiment, probability generator 120 is configured to provide the similarities 160 as multivariate input to a regression model (RM) 170 that is configured to generate relevancy probabilities 175. Relevancy probabilities 175 are scores that quantify likelihood that individual controls of the plurality of controls 140 are relevant to the target entity 135. In one embodiment, control extractor 125 is configured to apply a threshold 180 for relevance to the relevancy probabilities 175 to extract a listing of relevant controls 185. Listing of relevant controls 185 are a subset of plurality of controls 140 that are most relevant to the target entity 135. In one embodiment, alert generator 130 is configured to generate an electronic alert that includes the listing of controls 185.

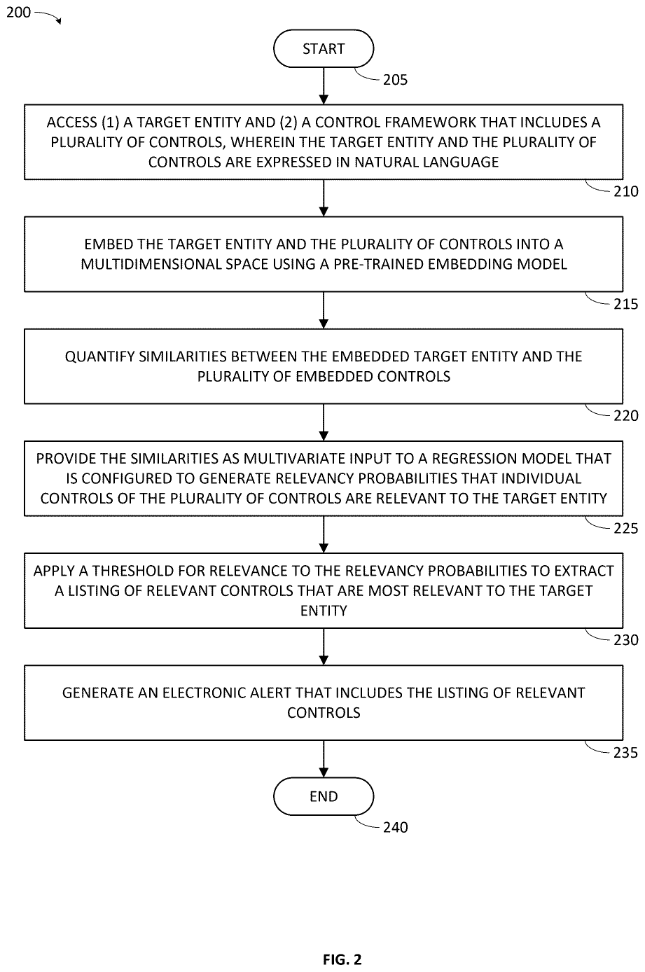

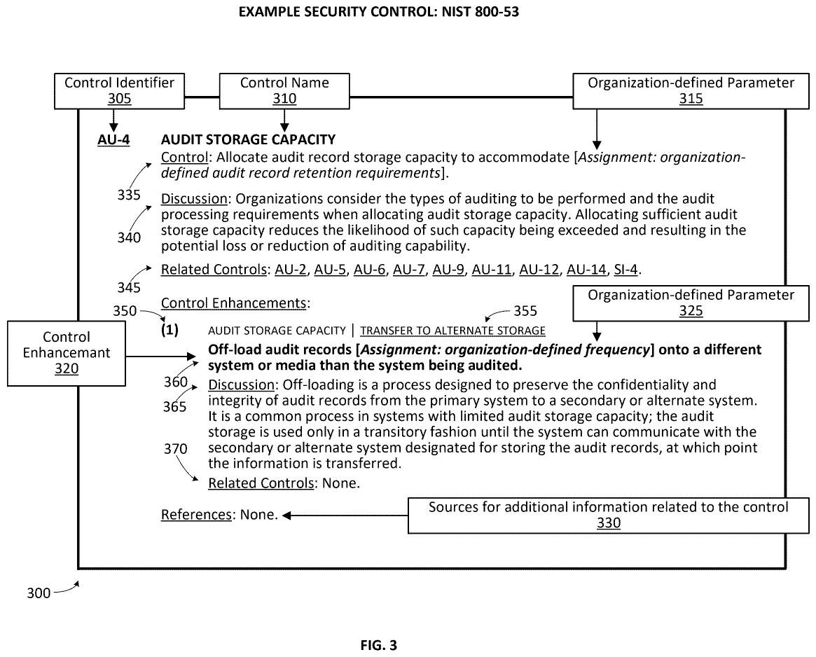

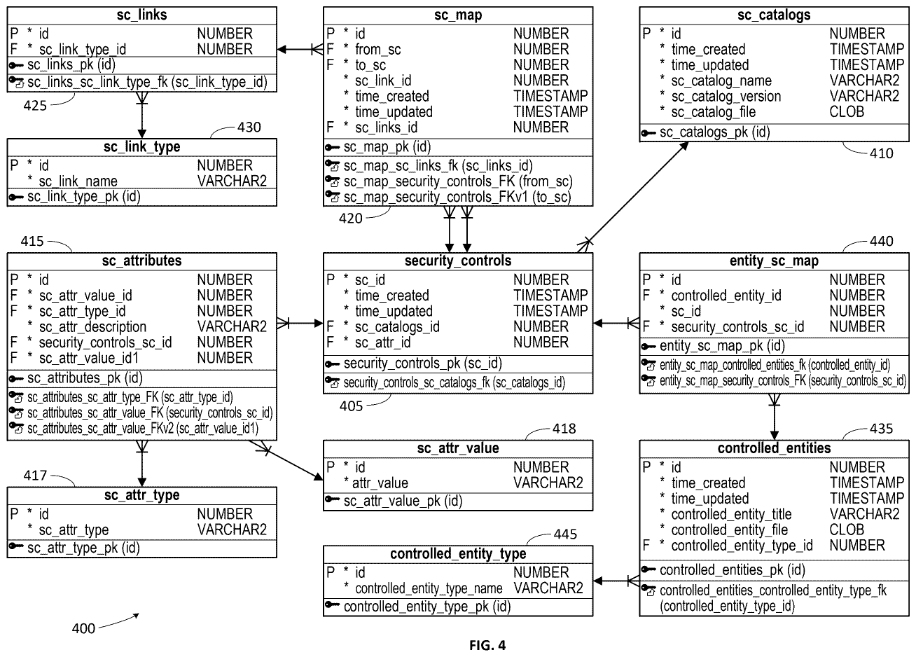

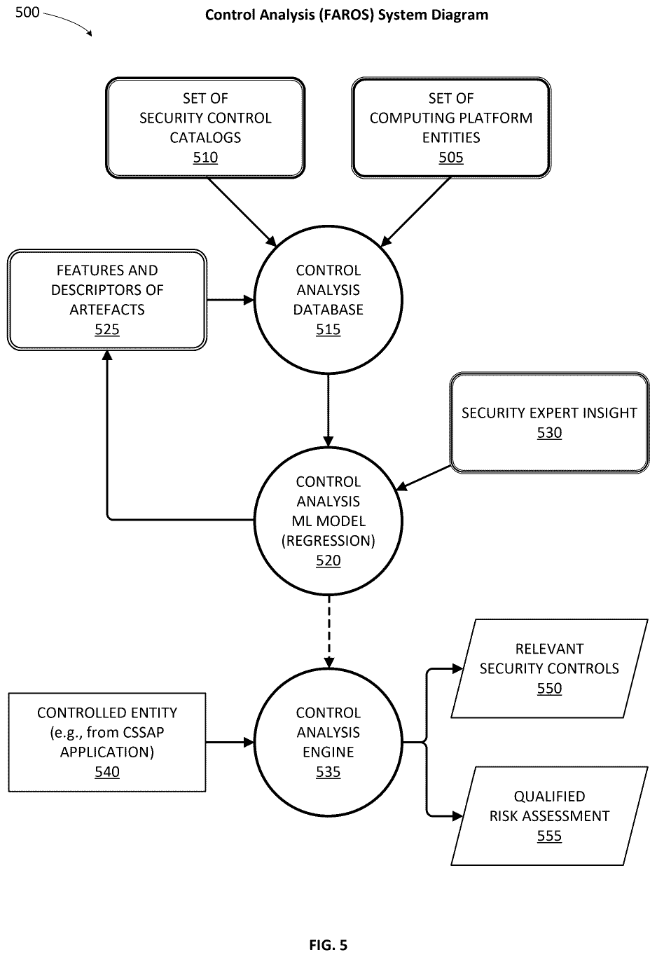

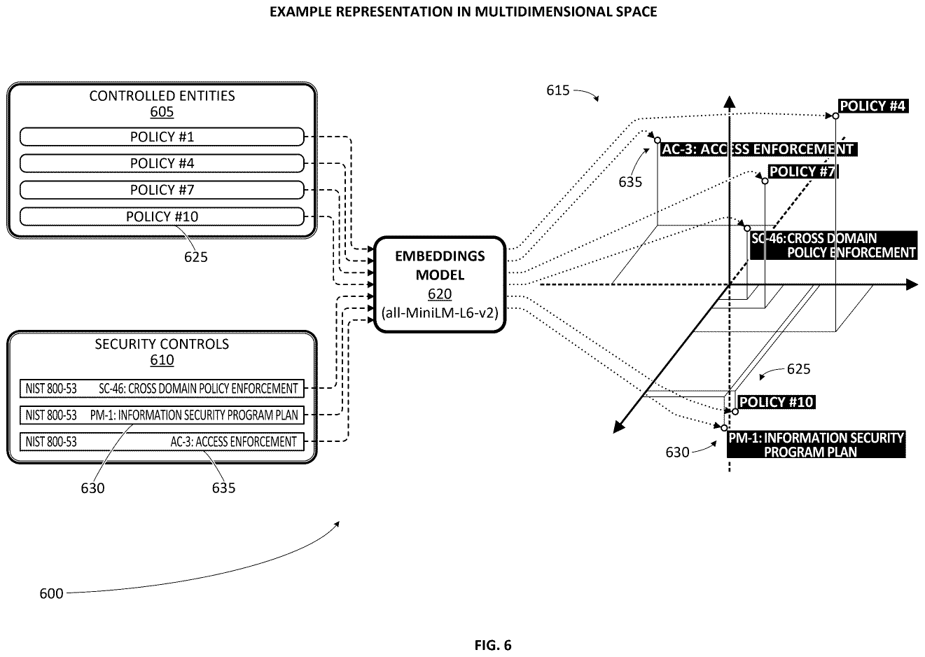

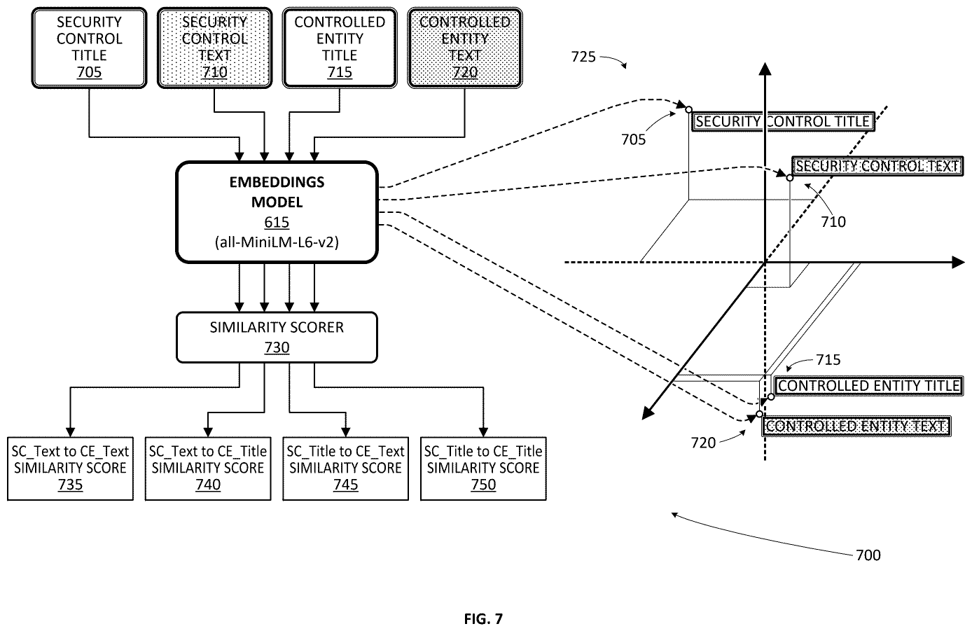

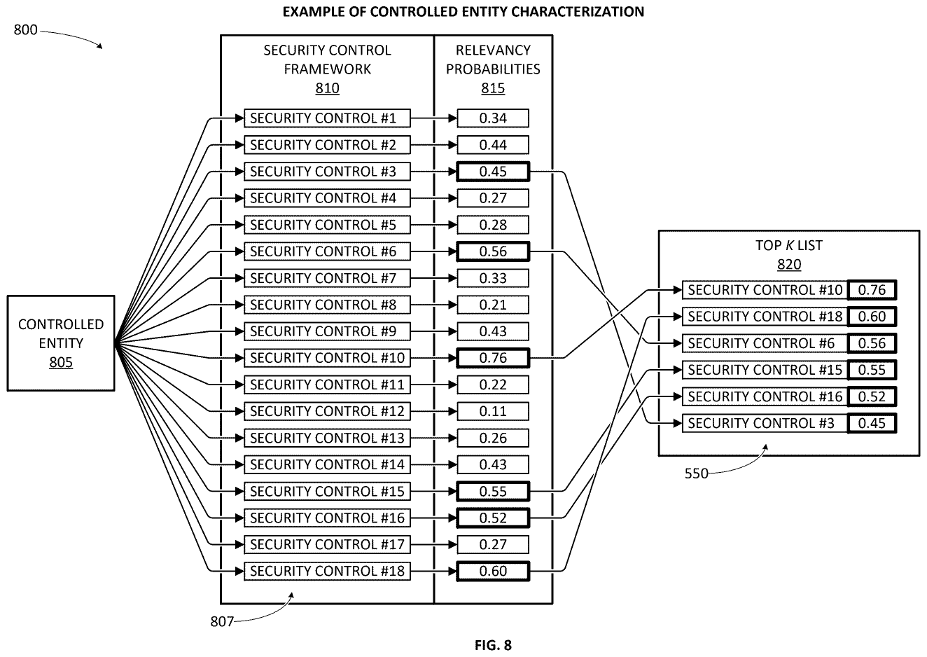

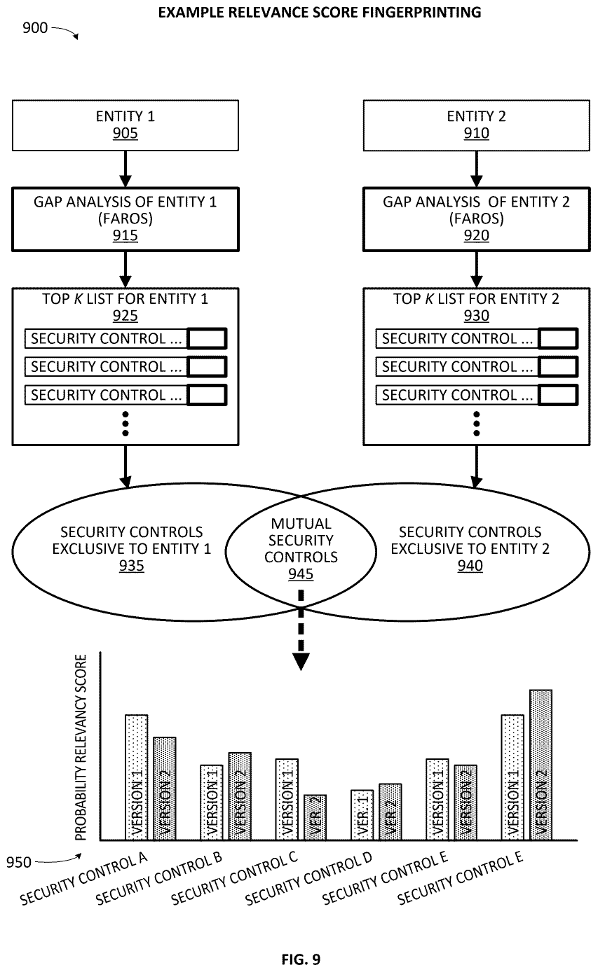

Further details regarding control analysis system 100 are presented herein. In one embodiment, operations of control analysis system 100 will be described with reference to control analysis method 200 of FIG. 2. In one embodiment, a structure of security controls for control analysis system 100 will be described with reference to example security control 300 of FIG. 3. In one embodiment, simplified example data structures for implementing control analysis system 100 will be described with reference to DB schema 400 of FIG. 4. In one embodiment, training and deployed operation of a regression model 170 for control analysis system 100 will be described with reference to system diagram 500 of FIG. 5. In one embodiment, embedding of target entities and controls for control analysis system 100 will be described with reference to diagram 600 of FIG. 6. In one embodiment, similarity scoring for control analysis system 100 will be described with reference to diagram 700 of FIG. 7. In one embodiment, relevancy analysis for control analysis system 100 will be described with reference to example flow 800 of FIG. 8. In one embodiment, comparison of security control relevance to two (or more) target entities in control analysis system 100 will be described with reference to example relevance score fingerprinting 900 of FIG. 9.

### Example Control Analysis Method

FIG. 2 illustrates one embodiment of a control analysis method 200 that is associated with providing an overview of alignment and risk when applying multiple security frameworks. In one embodiment, as a general overview, control analysis method 200 accesses a target entity and a control framework that includes more than one control. The target entity and the controls are expressed in natural language. Control analysis method 200 embeds the target entity and the controls into a multidimensional space using a pre-trained embedding model. Control analysis method 200 quantifies similarities between the embedded target entity and the embedded controls. Control analysis method 200 provides the similarities as multivariate input to a regression model. The regression model is configured to generate probabilities that individual controls are relevant to the target entity. Control analysis method 200 applies a threshold for relevance to the probabilities to extract a listing of relevant controls. The relevant controls are those of the controls that are most relevant to the target entity. And, control analysis method 200 generates an electronic alert that includes the listing of relevant security controls.

In one embodiment, control analysis method 200 initiates at START block 205 in response to control analysis system 100 determining that one or more conditions or events have been detected or have occurred. The conditions or events for initiating control analysis method 200, include, but are not limited to: (1) control analysis system 100 has received an instruction to determine which controls of a control framework are relevant to a target entity; (2) control analysis system 100 has received one or more target entities for analysis to determine relevant controls; (3) a user or administrator has initiated control analysis method 200; (4) it is currently a time at which control analysis method 200 is scheduled to be run; or (5) some other condition for commencing control analysis method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of control analysis system 100 executes control analysis method 200. In one embodiment, at START block 205, control analysis system 100 configures compute resources for performing control analysis method 200. (1) control analysis system 100 provisions (i.e., allocates and initializes) resources of the computing system that are used by control analysis system 100, such as processor, memory and storage (for example, for executing components of control analysis system 100). (2) control analysis system 100 establishes access to one or more networks for the resources, such as access to (a) internal networks for communication among components of control analysis system 100 and (b) external networks for communication with other computing systems (for example, client systems). (3) control analysis system 100 connects to data sources (such as databases, data stores, file systems, and cloud storage) used by the control analysis method 200. And, (4) control analysis system 100 configures the computing system with system settings, software dependencies and libraries, and modules for executing the components of control analysis system 100. Following initiation at START block 205, control analysis method 200 proceeds to block 210.

At block 210, control analysis method 200 accesses (1) a target entity and (2) a control framework that includes a plurality of controls. The target entity and the plurality of controls are expressed in natural language. In one embodiment, the control analysis method 200 obtains the target entity and controls from a control analysis database, such as shown and described below with reference to DB schema 400 and control analysis database 515. Control analysis method 200 thus fetches or loads both an entity for which pertinent controls are to be identified, and the set of controls that are to be considered.

Here, control analysis method 200 retrieves a dataset from storage. The dataset includes the plurality of controls. As an example, a control may be a data structure that includes NL description(s) of attributes of the control, for example as shown and described below with reference to example security control 300 and with reference to security controls in DB schema 400. The dataset also includes the target entity that is under consideration for relevance to the controls. As an example, a target entity may be a data structure that includes NL description(s) of attributes of the target entity, for example as shown and described below with reference to controlled entities in DB schema 400.

In one embodiment, for both controls and target entities, control analysis method 200 accesses a title attribute and stores the title attribute as a data element that is discrete from other NL description. In one embodiment, for both controls and target entities, control analysis method 200 accesses NL description attributes other than the title, concatenates the non-title NL description together into a text of the control or target entity, and stores the text as a data element that is discrete from the title. The titles and texts may be stored as strings or other textual data. The titles and texts of controls and target entities are thus separated for subsequent embedding.

In one embodiment, control analysis method 200 accesses (1) a target entity and (2) a control framework that includes a plurality of controls by the following steps. Control analysis method 200 composes a query, API call or other command that is configured to retrieve the target entity and plurality of controls from their respective storage locations, such as a SQL query to the control analysis database, a RESTful API call to a web service, or command to read files from a file system. Control analysis method 200 transmits the command for execution, and captures the data of the target entity and security controls that is returned. Control analysis method 200 converts the captured data to structures used by downstream processing, such as structures that include separate title and text elements. Control analysis method 200 makes text of the target entity and of the plurality of controls available for downstream processing, for example by providing electronic message(s) that carry the embeddings or indicate a location in storage where the embeddings may be retrieved.

In one embodiment, the steps of block 210 are performed by text handler 105. At the conclusion of block 210, control analysis method 200 has loaded the target entity and the controls into title-text data structures. Processing continues to block 215.

At block 215, control analysis method 200 embeds the target entity and the plurality of controls into a multidimensional space using a pre-trained embedding model. For example, control analysis method 200 inputs the title and text strings of the target entity and the controls into the embedding model, and captures numeric vectors returned by the embedding model that represent the input strings as coordinates in the multidimensional space. In short, control analysis method 200 executes the embedding model to create vector representations of the target entity and the controls.

In one embodiment, the embedding model is a machine learning model, such as a neural network or a transformer. The embedding model has been trained to encode linguistic, semantic, contextual, or other language properties of sentences (or paragraphs or other clauses) as numeric vectors of uniform length. Numbers in the vector are coordinates in a dimension of the multidimensional space that corresponds to the position occupied by the number in the vector. The numbers quantify the respective language properties represented by the corresponding dimension.

Control analysis method 200 uses the embedding model to convert the titles and texts of the target entity and the controls into vectors of numbers. In this way, the control analysis method 200 embeds meanings of the titles and texts in data structures—such as vectors or other lists of numbers—that have a consistent size. In one embodiment, control analysis method embeds the target entity and controls with separate embeddings for title text and for body text. As discussed above, title text is extracted from a title attribute of the control or target entity, and the body text is extracted from one or more other attributes that describe the control. The target entity and the controls may both be embedded into the same multidimensional space.

Control analysis method 200 embeds a target entity as a pair of numeric vectors: a first numeric vector that represents the title of the target entity and a second numeric vector that represents the text or non-title body of the target entity. In one embodiment, this pair of vectors for entity title and entity text make up embedded target entity 150. In one embodiment, where there are additional target entities, control analysis method 200 may further embed the additional target entities.

Control analysis method 200 also embeds individual controls as pairs of numeric vectors: a first numeric vector that represents the title of an individual control and a second numeric vector that represents the text or non-title body of the individual control. In one embodiment, control analysis method 200 embeds more than one of the controls, for example, the control analysis method may embed each control belonging to the plurality of controls 140. The one or more pairs of vectors for control title and control text make up embedded controls 155.

In one embodiment, control analysis method 200 embeds the target entity and the plurality of controls into a multidimensional space using a pre-trained embedding model as follows. For the following text strings—title of the target entity 135, body text of the target entity 135, titles of the plurality of controls 140, and body texts of the plurality of controls 140—control analysis method 200 inputs the text string to the embedding model, and captures the resulting numeric vector. To produce the numeric vector from the string, the embedding model (a) converts the text string into individual tokens, (b) processes the tokens with learned weights and transformations to generate a numeric vector of values for dimensions that quantify a meaning of the string. The control analysis method 200 associates the vectors for the title and body text of the target entity 135 in a data structure for an embedded target entity 150. The control analysis method 200 associates the vectors for the title and body text of an individual control in a data structure for an individual embedded control 155. The control analysis method 200 makes the embedded target entity 150 and the embedded controls 155 available for downstream processing, for example by providing electronic message(s) that carry the embeddings or indicate a location in storage where the embeddings may be retrieved.

In one embodiment, the steps of block 215 are performed by text embedder 110. At the conclusion of block 215, control analysis method 200 has embedded the target entity and the plurality of controls in a format conducive to similarity analysis at block 220. Processing continues to block 220.

At block 220, control analysis method 200 quantifies similarities between the embedded target entity and the plurality of embedded controls. For example, control analysis method 200 computes similarity scores between a vector of the target entity and vectors of each control. The similarity scores numerically characterize a degree or extent of similarity between the target entity and individual controls. In this way, control analysis method 200 measures how closely related the target entity is to the various controls.

In one embodiment, the similarity scores are determined for pairs of embedding vectors. Here, a pair of vectors includes a vector associated with the target entity and a vector associated with one of the controls. As discussed above with reference to block 215, the embedded target entity includes: (1) a numeric vector representation of the title of the target entity; and (2) a numeric vector representation of body text of the target entity. And, an individual embedded control includes: (1) a numeric vector representation of the title of the control; and (2) a numeric vector representation of body text of the control.

In one embodiment, the similarity scores are based on cosine similarity between the pairs of vectors. Cosine similarity assesses a cosine of an angle between two vectors, thereby quantifying similarity in orientation between a pair of vectors in the multidimensional space. In one embodiment, the similarity scores are based on Euclidean (that is, straight line) distances between the pairs of vectors. Euclidian distance quantifies proximity between vectors, thereby quantifying similarity in position between a pair of vectors in the multidimensional space.

In one embodiment, control analysis method 200 determines a similarity score between the body text of the control and the body text of the target entity (as embedded in numeric vectors). In one embodiment, control analysis method 200 determines a similarity score between the body text of the control and the title of the target entity (as embedded in numeric vectors). In one embodiment, control analysis method 200 determines a similarity score between the title of the control and the body text of the target entity (as embedded in numeric vectors). In one embodiment, control analysis method 200 determines a similarity score between the title of the control and the title of the target entity (as embedded in numeric vectors). In one embodiment, control analysis method 200 determines the foregoing four similarities of the embedded target entity 150 with respect to each of the plurality of embedded controls 155.

Control analysis method 200 then aggregates these similarity scores. For example, control analysis method 200 writes these similarity scores into a data structure. The data structure maintains association of the similarity score with (1) a particular individual control for which the score was generated, and (2) a type of score indicating that the score quantifies one of control body to entity body similarity (SC_Text-to-CE_Text), control body to entity title similarity(SC_Text-to-CE_Title), control title to entity body similarity (SC_Title-to-CE_Text), or control title to entity title (SC_Title-to-CE_Title) similarity. In one embodiment, the data structure is a feature vector associated with the target entity. The four similarity scores between the target entity and each of the plurality of controls may be written into one feature vector for the target entity. For example, for an example target entity CE, the feature vector FV with reference to a plurality of security controls SC1-SCN may be as follows: FV=[SC1_Text-to-CE_Text_Score, SC1_Text-to-CE_Title_Score, SC1_Title-to-CE_Text_Score, SC1_Title-to-CE_Title_Score,. SCN_Text-to-CE_Text_Score, SCN_Text-to-CE_Title_Score, SCN_Title-to-CE_Text_Score, SCN_Title-to-CE_Title_Score].

In one embodiment, control analysis method 200 quantifies similarities between the embedded target entity and the plurality of embedded controls as follows. Control analysis method 200 retrieves the numeric vector representations for both the title and body text of the target entity and each control from memory. Control analysis method 200 generates similarity scores between the embedding vectors of the title texts and body texts for the target entity and each individual control in turn, producing four similarity scores for each entity-control pair relationship. Control analysis method 200 organizes the generated similarity scores into a structured data format, such as a feature vector, associating each score with its corresponding control and specifying the type of textual relationship it represents (e.g., control body to entity body, control body to entity title, etc.). The control analysis method 200 makes the feature vector of similarity scores available for downstream processing, for example by providing electronic message(s) that carry the feature vector or indicate a location in storage where the feature vector may be retrieved.

In one embodiment, the steps of block 220 are performed by similarity scorer 115. At the conclusion of block 220, control analysis method 200 has quantified the similarity of the target entity with respect to the individual controls with similarity scores. The collection of these quantified similarities may be used to determine probabilities as to whether the individual controls are relevant to the target entity. Processing continues to block 225.

At block 225, control analysis method 200 provides the similarities as multivariate input to a regression model that is configured to generate relevancy probabilities that individual controls of the plurality of controls are relevant to the target entity. In one embodiment, control analysis method 200 generates relevancy probabilities that individual controls of the plurality of controls are relevant to the target entity based on the similarities using a regression model. The control analysis method 200 inputs the feature vectors of similarity scores produced above as input variables into a regression model (e.g., RM 170). The regression model operates to generate an estimated likelihoods for the individual controls that the controls pertain to the target entity. The similarity scores in the feature vector for a target entity thus serve as input data for the regression model. The regression model then processes these inputs to estimate probabilities that individual controls are relevant to the target entity.

Control analysis method 200 executes the regression model to generate the probabilities that the individual controls are relevant to the target entity. The regression model has been previously trained to interpret input similarity scores between a target entity and a plurality of controls (as collected in the feature vector) into relevancy probabilities that the target entity is relevant to the individual controls in the plurality. Control analysis method 200 loads and initiates the trained regression model. Control analysis method 200 inputs the similarity scores into the regression model, ensuring that each similarity score is correctly aligned with its corresponding feature input for the regression model. Control analysis method 200 executes the process of the regression model to generate a probability of relevancy to each control from the similarity scores provided for the plurality of controls.

In one embodiment, the regression model may be a logistic regression model. Alternatively, the ML model used to generate the relevancy probability may also be a probit regression model, a naïve Bayes classifier, or a neural network.

In one embodiment, the regression model is multivariate. For example, where there are N controls, the regression model accepts N×4 inputs, and produces N outputs. Here, the inputs are the four similarity scores (SC_Text-to-CE_Text, SC_Text-to-CE_Title, SC_Title-to-CE_Text, and SC_Title-to-CE_Title) scores for the target entity with respect to each control (contained in the feature vector for the target entity), and the outputs are the probabilities that each control is relevant to the target entity. The outputs may be expressed as a probability vector. For an example target entity CE, the probability vector PV of the relevance of a plurality of security controls SC1-SCN to the target entity CE may be as follows: PV=[SC1_Relevancy_Probability, SC2_Relevancy_Probability, . . . , SCN_Relevancy_Probability]. Relevancy probabilities 815, discussed below, is one example of a probability vector.

The regression model may be trained with a training dataset. The training dataset includes pairs of feature vectors of similarity scores as example input and associated vectors of Boolean relevancy determinations as example output. In the training dataset, the relevancy determinations are either 1, indicating relevant, or 0, indicating not relevant. The relevancy determinations are ground-truth labels for training.

In one embodiment, control analysis method 200 provides the similarities as multivariate input to a regression model and generates relevancy probabilities that individual controls of the plurality of controls are relevant to the target entity based on the similarities using the regression model as follows. The control analysis method 200 accesses the feature vectors containing similarity scores between the target entity and each control from memory. The control analysis method 200 loads and initiates a trained regression model, which is configured to process these feature vector inputs and has been previously trained or optimized for generation of the relevancy probabilities from the similarity scores. The control analysis method 200 inputs the similarity scores from the feature vectors into the corresponding inputs to the regression model. The control analysis method 200 executes the computational process of the trained regression model, which applies parameters learned in a prior training process to the input similarity scores to calculate the probability that each control is relevant to the target entity. For example, in linear regression, the regression model generates a weighted sum of the input similarity scores to be each relevancy score, using weights learned during training. In this way, the control analysis method 200 outputs a probability vector of relevancy probabilities, in which each relevancy probability represents a likelihood of a control being relevant to the target entity. The control analysis method 200 makes the probability vector of relevancy scores available for downstream processing, for example by providing electronic message(s) that carry the probability vector or indicate a location in storage where the probability vector may be retrieved.

In one embodiment, the steps of block 225 are performed by probability generator 120. At the conclusion of block 225, control analysis method 200 has determined a probability for each control as to whether the control is relevant to the target entity. Processing continues to block 230.

At block 230, control analysis method 200 applies a threshold for relevance to the relevancy probabilities to extract a listing of relevant controls that are most relevant to the target entity. For example, the control analysis method 200 applies a relevancy cutoff on the probabilities in the probability vector of relevancy scores to identify controls that are sufficiently likely to be relevant to the target entity that the identified controls may be presumed to be relevant. Application of the threshold on relevancy probability operates as a filter to retain controls that are deemed relevant to the target entity, and discarding controls that are deemed irrelevant to the target entity. In this way, control analysis method 200 compiles a list of controls that are most applicable to the target entity.

In one embodiment, the threshold is a minimum value m for relevancy probability. For example, a threshold of m=0.50 (on a scale of 0.00 to 1.00 for relevancy probability) may be an appropriate threshold for relevancy of a control, indicating that, more likely than not, the control is relevant to the target entity.

In one embodiment, the threshold is a maximum number (or cap) K of values considered to be relevant. For example, a top K controls with highest relevancy may be retained, for example as shown in top K list 820 below. In one embodiment, the value of K is proportional to the total number of controls. For example, the top 1/3 of controls in terms of relevancy probability may be an appropriate threshold for relevancy of a control. In another embodiment, the value of K is pre-specified number, such as K=10.

In one embodiment, the threshold is a condition combining aspects of the minimum value for relevancy and the cap on values considered to be relevant. For example, the threshold may operate to retain up to K controls with highest relevancy probability, provided that the relevancy probability for the controls exceeds a minimum value m.

In one embodiment, control analysis method 200 applies a threshold for relevance to the relevancy probabilities to extract a listing of relevant controls that are most relevant to the target entity as follows. Control analysis method 200 retrieves the relevancy probabilities generated for each control in relation to the target entity from memory or storage. For example, the control analysis method 200 loads the probability vector of relevancy scores. Control analysis method 200 Filters out controls whose relevancy probabilities do not satisfy the threshold for relevance. For example, where the threshold for relevancy is the top K scores that exceed a minimum value m, the control analysis method 200 (1) sorts the controls in descending order of relevancy probability, (2) discards controls that are not in the top K, and (3) further discards controls that are in the top K and which do not exceed the minimum value m. In this way, the relevant controls that meet the threshold criteria are retained in a filtered list, referred to occasionally herein as a listing of relevant controls 185. The control analysis method 200 makes the listing of relevant controls 185 available for downstream processing, for example by providing electronic message(s) that carry the embeddings or indicate a location in storage where the embeddings may be retrieved.

In one embodiment, the steps of block 230 are performed by control extractor 125. At the conclusion of block 230, control analysis method 200 has identified the subset of the controls that meet a minimum standard for relevance to the target entity. Processing continues to block 235.

At block 235, control analysis method 200 generates an electronic alert that includes the listing of relevant controls. For example, control analysis method 200 creates and transmits a computer-readable notification that incorporates the controls that were identified as relevant. The notification may also include information in addition to the relevant controls. The electronic alert may be configured to be transmitted over a network, such as a wired network, a cellular telephone network, wi-fi network, or other communications infrastructure. The electronic alert may be configured to be read by a computing device. The electronic alert may be configured to be displayed in a graphical user interface. The electronic alert may be configured as a request (such as a REST request) used to trigger initiation of an automated function, such as automated configuration changes to apply a relevant control to the target entity.

In one embodiment, control analysis method 200 generates an electronic alert that includes the listing of relevant controls 185 as follows. Control analysis method 200 retrieves the listing of relevant controls 185 of controls from memory or storage. Control analysis method 200 may also retrieve or generate additional information (if any) that is related to the listing of relevant controls, such as actionable instructions (e.g., for configuration updates) that can be executed in response to the notification. Control analysis method 200 selects a format for encapsulating the listing of relevant controls into a computer-readable notification for transmission, for example, a JSON, XML, or YAML format. Control analysis method 200 serializes the listing of relevant controls into the selected format, along with the additional information, and any metadata. Control analysis method 200 retrieves a destination for the electronic alert (e.g., broadcast, one or more recipient computing devices, etc.) and transmits the electronic alert over a designated network to the destination.

At the destination, the electronic alert may be received and interpreted by a recipient computing device. For example, the electronic alert may be displayed in a graphical user interface. Or, for example, the electronic alert may be processed further to trigger automated functions such as changes to the configuration of security measures applied to the target entity. In one embodiment, the electronic alert is formatted as a REST request to initiate the automated function, and includes parameters used by the automated action and authorization to perform the automated action. In one embodiment, an automated function to perform the automated action may include a script, Ansible playbook, or continuous integration/continuous deployment patch to apply one or more of the relevant security controls to the target entity.

In one embodiment, the steps of block 235 are performed by alert generator 130. At the conclusion of block 235, control analysis method 200 has output which of a set of controls (such as security controls) are applicable to a target entity. In one embodiment, processing continues to END block 240, where control analysis method 200 concludes.

In one embodiment, control analysis method 200 repeats. Here, control analysis method 200 restarts (at block 210) for an additional target entity. Note that, where the control framework remains the same for this subsequent iteration of the control analysis method, the plurality of controls will not need to be re-embedded, and the previously completed embeddings for the plurality of controls may be re-used.

### Example Additional Features of Control Analysis Method

In one embodiment, control analysis method 200 quantifies the similarities (as discussed with reference to block 220) based on similarities between titles and texts of the target entity and controls belonging to the plurality of controls. For example, control analysis method 200 may embed the target entity and the plurality of controls into a multidimensional space by generating separate embeddings for a title of the target entity, a text of the target entity, titles of the one or more controls, and texts of the one or more controls. Then, control analysis method 200 quantifies the similarities between the embedded target entity and the one or more embedded controls by, for the one or more controls, generating a vector of similarity scores. The vector of similarity scores includes: (1) a first similarity score between the embedded text of the control and the embedded text of the target entity; (2) a second similarity score between the embedded text of the control and the embedded title of the target entity; (3) a third similarity score between the embedded title of the control and the embedded text of the target entity; and (4) a fourth similarity score between the embedded title of the control and the embedded title of the target entity.

In one embodiment, control analysis method 200 determines the similarity score by cosine distance. For example control analysis method 200 quantifies the similarities by determining values of cosine similarity between the embedded target entity and the plurality of embedded controls.

Thus, in one embodiment, quantifying the similarities includes determining cosine distances between embeddings of one or more of the following pairs: (1) a text that describes the target entity and a text that describes the security control; (2) the text that describes the target entity and a title of the security control; (3) a title of the target entity and the text that describes the security control; and (4) the title of the target entity and the title of the security control.

In one embodiment, control analysis method 200 further includes steps to perform a relevance score fingerprinting analysis (such as shown and described below with reference to FIG. 9 below) to determine a set of mutual controls for the target entity and a second target entity. (The relevance score fingerprinting analysis also operates to detect security controls that are exclusive to the target entity and to the second target entity.)

As one example of the relevance score fingerprinting analysis, control analysis method 200 accesses a second target entity expressed in the natural language, for example as described with reference to block 210. Control analysis method 200 embeds the second target entity into the multidimensional space using the pre-trained embedding model, for example as described with reference to block 215. Control analysis method 200 quantifies second similarities between the embedded second target entity and the plurality of embedded controls, for example as described with reference to block 220. Control analysis method 200 provides the second similarities as a second multivariate input to the regression model to generate second probabilities that the individual controls of the plurality of controls are relevant to the second target entity, for example as described with reference to block 225. Control analysis method 200 applies the threshold for relevance to the second probabilities to extract a second listing of relevant controls that are most relevant to the second target entity, for example as described with reference to block 230. Then, control analysis method 200 proceeds to determine a set of mutual controls for the target entity and the second target entity that are in both the listing of relevant controls and the second listing of relevant controls, for example as described below with reference to mutual security controls 945. And, control analysis method 200 generates a chart that compares the relevance of the mutual controls to the target entity and the second target entity, for example as described below with reference to chart 950.

Relevance score fingerprinting may be used to characterize the relative conformance of a plurality of versions of a target entity with the control framework. Thus, in one embodiment, the second target entity is a changed version of the first target entity.

Relevance score fingerprinting may be used to characterize a newly emerging security threat with respect to the control framework. Thus, in one embodiment, the first target entity is a newly emerging cybersecurity threat and the second target entity is a software entity (for example, in in a cloud tenancy). Here, control analysis method 200 further, in real-time, identifies the second target entity as being affected by the emerging cybersecurity threat based on the mutual controls.

Relevance score fingerprinting may be used to identify whether specific attack vectors or other adversarial techniques are addressed by security controls already in place. Accordingly, in one embodiment, the second target entity is an additional control belonging to a threat attack database. The additional control from the threat attack database describes an attack vector or other adversarial technique to be defended against.

In one embodiment, generating the electronic alert (as described above with reference to block 235) further includes adding a risk assessment of the target entity in the electronic alert. For example, the control analysis method 200 may further detect a gap in coverage by the target entity (e.g., with respect to the controls, or with respect to a second target entity), and include the gap (such as a description of the gap) in the electronic alert. In response to the electronic alert, control analysis method 200 automatically updates the target entity to close the gap. Or, for example, the control analysis method 200 may further confirm continuous coverage by the target entity (e.g., with respect to the controls, or with respect to a second target entity), and include the confirmation in the electronic alert.

In one embodiment, the control analysis method 200 may be used to automatically map the controls of one control framework to the controls of another control framework. Where the target entity is included in a second control framework, control analysis method 200 further generates a mapping of the control framework to the second control framework and includes the mapping in the electronic alert. For example, the mapping may include relationships of the target entity and other entities of the second control framework to the controls of the initial control framework. Thus, the electronic alert may include a mapping of the control framework to the second control framework.

In one embodiment, the embedding model is a transformer that is configured to encode language properties (such as linguistic, semantic, and contextual properties) as features. For example, the embedding model may be a MiniLM model.

In one embodiment, the control analysis method 200 performs steps to automatically detect and close security gaps in real-time in response to an emerging cybersecurity threat. For example, where the target entity a description of an emerging cybersecurity threat, the control analysis system 200 further automatically identifies the listing of relevant security controls in real-time. The relevant security controls are relevant to the emerging cybersecurity threat. Based on the relevant security controls, the control analysis system 200 automatically identifies one or more affected entities in the computing system to be affected by the emerging cybersecurity threat. Then, the control analysis system 200 detects a gap between the relevant security controls and security controls applied to the affected entities in real-time, and include the gap in the electronic alert. And, in response to the electronic alert, the control analysis system 200 automatically deploys configuration changes in the system to close the gap.

### Context and Discussion of Control Analysis

In one embodiment, the control analysis system uses a natural language processing (NLP)/representation space (RS) toolkit for security control mapping. And, in one embodiment, the control analysis system uses quantified relevance scores as a featurization mechanism to represent controlled entities for analysis.

The requirements to implement certain security measures and features are defined in terms of natural language SCs and SFs. Multiple CEs impose requirements to implement or satisfy numerous SCs. But, such CEs express the requirements with nothing more than natural language fragments or snippets, or even by parametric statements in some cases. Thus, the applicable SCs are not mentioned or specified explicitly by the CEs. This lack of association between CE and SC presents a substantial challenge to the security and trustworthiness of conformance assurance.

In one embodiment, the control analysis system 100 operates to enhance the security and trustworthiness of conformance assurance. In one embodiment, the control analysis system 100 extracts SCs from one or more SFs and then characterizes the relevance of individual SCs to CEs based at least in part on NLP and RS tools. In one embodiment, control analysis system 100 may be referred to as “frameworks alignment and risk overview system” or “FAROS.”

FIG. 3 illustrates one example security control 300 that is associated with providing an overview of alignment and risk when applying multiple security frameworks. Example security control 300 is one individual security control drawn from the NIST 800-53 framework. The example security control 300 has a control identifier 305, “AU-4.” The example security control 300 has a control name 310, “AUDIT STORAGE CAPACITY.” The example security control 300 includes a first organization-defined parameter 315, a set of organization-defined audit record retention requirements. The example security control 300 may include one or more control enhancement(s) 320, such as to off-load audit records at an organization-defined frequency onto a different system or media than the system being audited. The organization-defined frequency for off-loading is a further organization-defined parameter 325. In some cases, example security control 300 includes references 330, which are sources for additional information related to the control.

In one embodiment, a security control such as example security control 300 may be represented as one or more data structures, for example in a database (DB). The data structures for a security control may include elements for various information included in the security control. For example, a security control may have elements for the control identifier (e.g., control identifier 305), the control name (e.g., control name 310), a control definition (e.g., control definition 335), one or more organization-defined parameters for the control definition (e.g., organization-defined parameter 315), a discussion of the control (e.g., discussion 340), a listing of related controls that are related to the security control (e.g., related controls 345), a set of control enhancements (e.g., control enhancement 320), and a listing of locations for further information related to the control (e.g., references 330).

As a further example, a control enhancement may be represented as one or more data structures. The data structures for a control enhancement may include elements for various information included in the control enhancement. The control enhancement may include an enhancement identifier (e.g., identifier 350), an enhancement name (e.g., enhancement name 355), an enhancement definition (e.g., enhancement definition 360), one or more organization defined parameters for the enhancement definition (e.g., organization-defined parameter 325)), a discussion of the enhancement (e.g., discussion 365), and a listing of related controls that are related to the enhancement (e.g., related controls 370).

FIG. 4 illustrates a simplified example DB schema 400 for a DB that is associated with providing an overview of alignment and risk when applying multiple security frameworks. Multiple security control frameworks are text-parsed into a machine-readable format and stored in the DB as atomized individual security control records.

DB schema 400 includes a central table security_controls 405, which stores data about individual security controls. Security_controls 405 is connected by foreign key (FK) sc_catalogs_id to a table of security frameworks, sc_catalogs 410, which serves to group individual controls by framework.

Security_controls 405 is connected by FK sc_attr_id to a table of attributes and metadata of individual security controls, sc_attributes 415. Sc_attributes 415 serves to describe functionality and features of individual security controls. Through FK sc_attr_type_id, sc_attr_type 417 defines categories or types of the attributes and metadata that can be associated with security controls. Through FK sc_attr_value_id1, sc_attr_value 418 holds the values of attributes assigned to individual security controls.

Individual security controls of security_controls 405 are linked to each other by junction table sc_map 420, which serves to manage relationships (such as dependencies or hierarchical structures) from one security control (FK from_sc) to another (FK to_sc). Through FK sc_links_id, sc_links 425 provides sc_map 420 with a reference repository that defines a type or nature of a relationship between security controls. And, through FK sc_link_type_id, sc_link_type 430 assigns names to particular types of relationship found in sc_links 425.

Individual security controls of security_controls 405 are linked to individual controlled entities of controlled_entities 435 by junction table entity_sc_map 440. Entity_sc_map 440 serves to link or associate individual controlled entities by way of FK controlled_entity_id with security controls by way of FK security_controls_sc_id. Controlled_entities 435 provides a list of entity that are linked to security controls though entity_sc_map 440. Controlled_entity_type 445 classifies controlled entities by type of the controlled entity (such as server, application, database, etc.) through FK controlled_entity_type_id.

FIG. 5 illustrates one embodiment of a control analysis (FAROS) system diagram 500 that is associated with providing an overview of alignment and risk when applying multiple security frameworks. In this example of the control analysis system, textual data from the existing controlled entities (set of computing platform entities 505) and from the security frameworks (set of security control catalogs 510) are stored in a DB (control analysis database 515). The data stored in the control analysis database 515 are utilized to adopt and train a machine learning model (control analysis ML model 520) to perform a control analysis using a control analysis engine 535 (for example as described above with reference to control analysis method 200).

Additional information (features and descriptors of artefacts 525) extracted from controlled entities by the control analysis ML model 520 may be stored in the control analysis database 515 and used for further training of the control analysis ML model 520. Further, security expert insight 530 may also be provided to modify or enhance control analysis ML model 520. Once trained or configured, the control analysis ML model may be deployed to the control analysis engine 535 to analyze controlled entities for relevance to security controls.

In the control analysis engine 535, the trained ML model 520 takes a controlled entity 540 as an input and yields a vector of relevance scores. (Controlled entity 540 is one example of a target entity 135 that is being analyzed for relevance to security controls 140.) In one embodiment, the controlled entity 540 is received from an application or program for managing the security of a compute architecture, such as for mandated security assurance operations. In the vector of relevance scores for the controlled entity 540, each individual vector component corresponds to a relevance level of a particular security control in question. The control analysis 535 produces a listing of relevant security controls 550, which are security controls from set of security control catalogs 510 which are most likely to be applicable to the controlled entity 540. And, the control analysis 535 automatically produces a qualified risk assessment 555 of the controlled entity 540, which identifies gaps of security controls that are applicable to the controlled entity 540 and prioritizes correction of the gap by likelihood and impact of a threat related to the gap.

Sentence embedding is numeric representation of a sentence in the form of vector. The sentence (or other clause of language) is encoded as a vector of feature scores for various semantic, syntactic, and/or contextual dimensions of the sentence to capture meaning of the sentence. The embedding enables comparison of sentence similarity by quantifying the proximity of their embeddings, with closer vectors representing more similar meanings. These embeddings may be generated using pre-trained models (PTM or embedding model)—such as transformers—trained to encode contextual and semantic nuances as features. Examples of transformers that may be used as the embedding model include BERT (Bidirectional Encoder Representations from Transformers), RoBERTa (Robustly Optimized BERT Approach), Sentence-BERT, MiniLM (Miniature Language Model), and GPT (Generative Pre-trained Transformer).

The embedding model may be pre-trained with a wide variety of texts from books, websites, newspapers, and so on to develop an understanding of language. The embedding model may be fine-tuned to a domain of security controls and controlled entities. The fine-tuning causes the model to capture nuances such as specialized terminology, regulations, or common phraseology relevant to the domain of security controls and controlled entities. For example, the embedding model may be fine-tuned with a training dataset that includes texts and titles of controlled entities and of controls from control frameworks to improve performance of the embedding model in the domain of control frameworks and controlled entities.

Individual controlled entities are embedded for processing by control analysis ML model 520. For example, a fine-tuned PTM generates embeddings for each of the controlled entities in question. Thus, the text clauses in the controlled entities are transformed into a multivariable vector representation which are otherwise known as embeddings. The embeddings represent clauses (e.g. sentences or phrases) of the description of the controlled entity as numeric vectors. These embeddings are used to establish semantic similarity between a security control and an entity. For example, semantic similarity may be determined by the cosine similarity between the embeddings that represent two pieces of text.

FIG. 6 illustrates a diagram 600 of an example representation of entities in multidimensional space that is associated with providing an overview of alignment and risk when applying multiple security frameworks. Diagram 600 demonstrates how embeddings afford the ability to represent discrete entities from both a set of controlled entities 605 and a set of security controls 610 in a multidimensional space 615.

An embedding model 620 embeds clauses of the entities into the multidimensional space. As discussed above, the embedding model 620 is a fine-tuned PTM. For example, the embedding model 620 may be a MiniLM (Minimal Language Model) model, such as all-MiniLM-L6-v2, which includes six transformer layers. The all-MiniLM-L6-v2 produces embeddings in a space with 384 dimensions. (In diagram 600, the multidimensional space shows just three of the available dimensions for ease of comprehension.) Models producing embeddings with higher or lower dimensionality may also be suitable.

The embeddings allow for the control analysis engine 535 to measure semantic similarity or dissimilarity between text descriptions of entities based on proximity. For example, the embeddings of the controlled entity Policy 10 625 and the security control PM-1: Information Security Program Plan 630 are shown to be relatively proximate to each other, while the embeddings of Policy 10 625 and the security control AC-3: Access Enforcement 635 are shown to be relatively more distant from each other. These distances may be measured by Euclidean distance between the respective embeddings.

FIG. 7 illustrates a diagram 700 of similarity scoring the control analysis engine 535 that is associated with providing an overview of alignment and risk when applying multiple security frameworks. Diagram 700 demonstrates how similarity scores between pairs of entities may be obtained from embeddings of text associated with the entities. For example, a security control title 705 and a security control text 710, as well as a controlled entity title 715 and a controlled entity text 720 are each embedded into a multidimensional space 715 by embeddings model 615. A similarity scorer 730 then generates feature vectors for the entities.

In one embodiment, similarity scorer 730 determines similarity between security control (SC) entities and controlled (CE) entities in the following manner. An individual entity (including both SC entities and CE entities) is represented by a title and a text that describes the entity. The control analysis engine 535 compares the title and text of one or more (e.g., all) CE entities to one or more (e.g., all) SC entities to produce vector of comparison features. In one embodiment, the features are distances between the title and text of CE entities and the title and text of SC entities.

In one embodiment, the distances are Euclidean (or straight-line) distances which are found by determining a square root of a sum of squared differences between corresponding coordinates of the embeddings. Other distance measures may also be appropriate, including, but not limited to: (1) cosine distance, which is found by finding the complement of the dot-product of the embeddings divided by the product of the magnitudes of the embeddings; (2) Manhattan distance (or L1 norm), which is found by determining a sum of absolute differences between coordinates of the embeddings; and (3) Jaccard distance, which is found by finding the complement of the magnitude of the intersection of the elements of the embeddings divided by the magnitude of the union of the elements of the embeddings.

A feature vector for an entity includes, as its features, distances between the embeddings of titles and texts of the entities. For example, the feature vector for a given controlled entity might include the following four features for one or more security controls: (1) an SC_Text-to-CE_Text similarity score 735, which is a distance between the embedding of the text of the security control and the embedding of the text of the controlled entity; (2) an SC_Text-to-CE_Title similarity score 740, which is a distance between the embedding of the text of the security control and the embedding of the title of the controlled entity; (3) an SC_Title-to-CE_Text similarity score 745, which is a distance between the embedding of the title of the security control and the embedding of the text of the controlled entity; and (4) an SC_Title-to-CE_Title similarity score 750, which is a distance between the embedding of the title of the security control and the embedding of the title of the controlled entity. In one embodiment, the feature vector for a given controlled entity includes an SC_Text-to-CE_Text similarity score 735, an SC_Text-to-CE_Title similarity score 740, an SC_Title-to-CE_Text similarity score 745, and an SC_Title-to-CE_Title similarity score 750 for each of the security controls in a security control framework. In other words, the feature vector for a controlled entity has these four similarity scores with respect to each security control.

Next, the control analysis engine 535 characterizes one or more controlled entities in terms of a set of most relevant security controls. In one embodiment, control analysis engine 535 employs a multivariate regression model to predict the relevance of the controlled entities to the security control entities. In one embodiment, the multivariate regression model is a logistic regression model. This is a statistical method for binary classification that estimates the probability of a binary response—in this case, probability that a security control is relevant to a controlled entity—based on predictor variables or features. In one embodiment, the multivariate regression model accepts the feature vector for a controlled entity as inputs, and generates a vector of relevancy probabilities corresponding to security controls as outputs. This may be repeated for one or more (or all) controlled entities in the set of controlled entities, generating vectors of relevancy probabilities for the individual controlled entities in the set. In one embodiment, for each entity from the CE set, the control analysis engine 535 sorts and retrieves a set of top K entities from the SC set based on predicted relevancy of the logistic regression model calculated.

FIG. 8 illustrates an example flow 800 of controlled entity characterization that is associated with providing an overview of alignment and risk when applying multiple security frameworks. A controlled entity 805 is associated with similarity scores for the security controls 807 included in a security control framework 810. For example, a data structure for the controlled entity 805 includes a feature vector that has the four similarity scores 735, 740, 745, and 750 for each of the security controls 807. This feature vector for the controlled entity 805 is populated by embeddings model 615 and similarity scorer 730 as discussed above.

The control analysis engine 535 provides the feature vector for the controlled entity 805 as input to the multivariate regression model. From the similarity scores in the feature vector, multivariate regression model generates relevancy probabilities 815 for the individual security controls 807. Individual relevancy probabilities 815 indicate a likelihood (between 0 and 1) that the associated security control is relevant to the controlled entity 805.

Finally, the control analysis engine 535 applies a pre-specified threshold to the relevancy probabilities 815 to distinguish between ‘relevant’ and ‘not relevant’ to determine relevant security controls 550. The pre-specified threshold may be established, for example (1) based on a given problem, (2) based on an opinion of a subject domain expert, or (3) based on some other constraint depending on the task at hand. In example flow 800, the threshold is set at 0.45 and greater. This yields a top K list 820, that designates security controls that satisfy the threshold for relevancy probability to be the relevant security controls 550. In one embodiment, the top K list 820 may include as many of the security controls as satisfy the threshold. In one embodiment, the top K list 820 places a pre-determined cap K on the number of security controls that may be considered relevant. Here, the security controls that satisfy the threshold for relevancy probability are further sorted in order of relevancy probability, and the K security controls that have highest relevancy probability are retained as the relevant security controls 550, and the remaining scores that satisfy the threshold are not included.

Note that, in one embodiment, the types and the scope of the frameworks being analyzed are not limited to security and may represent broader sets of countermeasures that can encompass reliability, efficiency, safety, healthcare, or other domains.

In one embodiment, the system can identify the gaps or duplication in the security control coverage when making a transition (switch) from one security framework to another. FIG. 9 illustrates one example of relevance score fingerprinting 900 of a plurality of controlled entities being used for gap and duplication detection that is associated with providing an overview of alignment and risk when applying multiple security frameworks. Relevance score fingerprinting 900 detects overlap or gap in coverage by a security control framework.

In one embodiment, relevance score fingerprinting 900 performs gap analyses (as discussed above) for two distinct controlled entities, entity 1 905 and entity 2 910, with reference to one set of security controls applied to both entity 1 905 and entity 2 910. Control analysis of entity 1 915 determines relevance probabilities of the individual security controls in the set to entity 1 905. Control analysis of entity 2 920 determines relevance probabilities of the individual security controls in the set to entity 2 910. Control analysis of entity 1 915 produces a top K list for entity 1 925 of security controls that are most relevant to entity 1 905. Control analysis of entity 2 920 produces a top K list for entity 2 930 of security controls that are most relevant to entity 2 910.

The top K security controls for entity 1 905 may differ from the top K security controls for entity 2 910. There may be security controls exclusive to entity 1 935 which are relevant to entity 1 905, and not relevant to entity 2 910. There may be security controls exclusive to entity 2 940 which are relevant to entity 2 910, and not relevant to entity 1 905. And there may be mutual security controls 945 which are relevant to both entity 1 905 and entity 2 910. In one embodiment, the control analysis system accepts the top K list for entity 1 925 and the top K list for entity 2 930 as inputs to a process to detect mutual security controls 945. The process compares the security controls in the top K list for entity 1 925 and the security controls in the top K list for entity 2 930 to detect pairs of a security control from the respective top K lists 925, 930 that match each other. Where a match is detected, the security control is assigned to the mutual security controls 945. The probability relevancy scores with respect to controlled entity 1 905 and controlled entity 2 910 for the individual mutual security controls 945 may be stored in association with each other as a data structure.

The relevancies of the mutual security controls 945 to the controlled entities (entity 1 905 and entity 2 910) may then be presented in a chart 950. The control analysis system generates chart 950. The control analysis system generates Chart 950 by: (1) accessing the probability relevancy scores for the various mutual security controls 945 with respect to entity 1 905 and entity 2 910, (2) mapping the relevancy scores to positions (e.g., heights of bars) within a coordinate system of chart 950, (3) rendering chart 950 using a graphical rendering tool such as matplotlib, D3.js, or Java 2D API, and (4) transmit the rendered chart 950 for display in a graphical user interface.

In a variation, the system can also characterize individual controlled entities in terms of a given security framework by automatically assigning a vector of the relevance score values.

### Various Advantages of Control Analysis System

There are multiple modalities of leveraging framework maps generated by the control analysis system in a security control analytics space.

For example, the control analysis system improves the technology of data security by automatically identifying the set of security controls that are pertinent to newly emerging threat, and automatically identifying cloud computing tenancies, projects, and other entities subject to the pertinent security controls. In one embodiment, the automated security control and affected entity identification is performed near or in real time.

In another example, the control analysis system improves the technology of data security by enabling automated reverification of compliance and conformance upon addition of one or more new security controls to a framework.

In another example, the control analysis system improves the technology of data security by enabling optimization and verification (for non-contradiction, congruence, and continuous coverage) of a newly introduced policy or standard against existing security artefacts and controlled entities.

In another example, the control analysis system improves the technology of data security by enabling automated changes to control frameworks due to new requirements (from, e.g., a customer or governing organization).

In another example, the control analysis system improves the technology of data security by enabling rapid design of highly targeted, compact, individuated frameworks for human-in-the-loop incident response inversely from a given security issue, threat and a given installation such as conformance assurance during major company acquisition, evolving security breaches and threats, and incidents.

In another example, the control analysis system improves the technology of data security by providing framework-to-framework mapping, in which the control analysis system automatically generates and maintains a map reflecting the relationships between two security control frameworks.

In another example, the control analysis system improves the technology of data security by automatically identifying relevant security controls for software security assurance standards tools, such as Oracle Software Security Assurance (OSSA). For example, sample cybersecurity standards provided as inputs to the control analysis system results in the control analysis system output of the top relevant security controls from a pre-designated security framework, e.g., NIST SP 800-53 Rev.5.

In another example, the control analysis system improves the technology of data security by automatically characterizing a cybersecurity threat or attack in terms of security controls. A threat attack database, such as MITRE ATT&CK (Adversarial Tactics, Techniques, and Common Knowledge), provides a highly detailed and comprehensive taxonomy of adversary tactics and techniques. The threat attack database is an example security framework for interpreting and registering various tactics, techniques and procedures (TTP's) used by attackers during a cyberattack. The control analysis system operates to bridge the gap between (1) anomaly detectors and security safeguards of an entity and (2) the real world in terms of security controls. By keeping track of the representative threat catalog or knowledge base the control analysis system may be leveraged to identify the need for novel security detectors or identify subsystem or cloud infrastructure tenancy vulnerability with respect to new threats. Control analysis system may perform such desired overlap or gap detection for example as shown and described above with reference to FIG. 9.

### Cloud or Enterprise Embodiments

In one embodiment, the present system (such as control analysis system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, control analysis system 100 is a centralized server-side application that provides at least the functions disclosed herein and that is accessed by many users by way of computing devices/terminals communicating with the computers of control analysis system 100 (functioning as one or more servers) over a computer network. In one embodiment control analysis system 100 may be implemented by a server or other computing device configured with hardware and software to implement the functions and features described herein.

In one embodiment, the components of control analysis system 100 may be implemented as sets of one or more software modules executed by one or more computing devices specially configured for such execution. In one embodiment, the components of control analysis system 100 are implemented on one or more hardware computing devices or hosts interconnected by a data network. For example, the components of control analysis system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of control analysis system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of control analysis system 100 may (i) generate or compose an electronic message or signal to issue a command or request to another component, (ii) transmit the message or signal to other components of control analysis system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by control analysis system 100, for example through a web interface server. In one embodiment, the remote computing system may send requests to and receive responses from control analysis system 100. In one example, access to the information or applications may be effected through use of a web browser on a personal computer or mobile device. In one example, communications exchanged with control analysis system 100 may take the form of remote representational state transfer (REST) requests using JavaScript object notation (JSON) as the data interchange format for example, or simple object access protocol (SOAP) requests to and from XML servers. The REST or SOAP requests may include API calls to components of control analysis system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

In one embodiment, control analysis systems and methods described herein may be implemented by using a computer program product, comprising computer program/instructions which, when executed by a processor, cause the processor to perform any of the methods described in the disclosure.

### Computing Device Embodiment

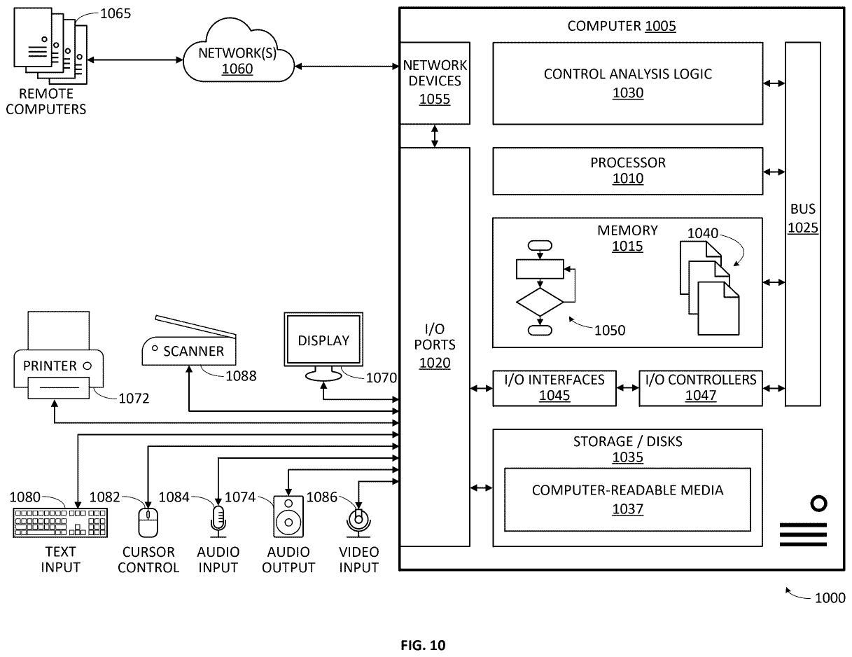

FIG. 10 illustrates an example computing system 1000 that is configured and/or programmed as a special purpose computing device(s) with one or more of the example systems and methods described herein, and/or equivalents. The example computing device may be a computer 1005 that includes at least one hardware processor 1010, a memory 1015, and input/output ports 1020 operably connected by a bus 1025. In one example, the computer 1005 may include control analysis logic 1030 configured to facilitate provision of an overview of alignment and risk when applying multiple security frameworks, similar to the logic, systems, methods, and other embodiments shown in and described with reference to FIGS. 1-9.

In different examples, the logic 1030 may be implemented in hardware, one or more non-transitory computer-readable media 1037 with stored instructions, firmware, and/or combinations thereof. While the logic 1030 is illustrated as a hardware component attached to the bus 1025, it is to be appreciated that in other embodiments, the logic 1030 could be implemented in the processor 1010, stored in memory 1015, or stored in disk 1035.

In one embodiment, logic 1030 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) or field-programmable gate array (FGPA) that is programmed to facilitate provision of an overview of alignment and risk when applying multiple security frameworks. The means may also be implemented as stored computer executable instructions that are presented to computer 1005 as data 1040 that are temporarily stored in memory 1015 and then executed by processor 1010.

Logic 1030 may also provide means (e.g., hardware, non-transitory computer-readable medium that stores executable instructions, firmware) for performing one or more of the disclosed functions and/or combinations of the functions.

Generally describing an example configuration of the computer 1005, the processor 1010 may be a variety of various processors including dual microprocessor and other multi-processor architectures. A memory 1015 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 1035 may be operably connected to the computer 1005 via, for example, an input/output (I/O) interface (e.g., card, device) 1045 and an input/output port 1020 that are controlled by at least an input/output (I/O) controller 1047. The disk 1035 may be, for example, a magnetic disk drive, a solid-state drive, a floppy disk drive, a tape drive, a Zip drive, a flash memory card, a memory stick, and so on. Furthermore, the disk 1035 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 1015 can store a process 1050 and/or a data 1040, for example. The disk 1035 and/or the memory 1015 can store an operating system that controls and allocates resources of the computer 1005.

The computer 1005 may interact with, control, and/or be controlled by input/output (I/O) devices via the input/output (I/O) controller 1047, the I/O interfaces 1045, and the input/output ports 1020. Input/output devices may include, for example, one or more network devices 1055, displays 1070, printers 1072 (such as inkjet, laser, or 3D printers), audio output devices 1074 (such as speakers or headphones), text input devices 1080 (such as keyboards), cursor control devices 1082 for pointing and selection inputs (such as mice, trackballs, touch screens, joysticks, pointing sticks, electronic styluses, electronic pen tablets), audio input devices 1084 (such as microphones or external audio players), video input devices 1086 (such as video and still cameras, or external video players), image scanners 1088, video cards (not shown), disks 1035, and so on. The input/output ports 1020 may include, for example, serial ports, parallel ports, and USB ports.

The computer 1005 can operate in a network environment and thus may be connected to the network devices 1055 via the I/O interfaces 1045, and/or the I/O ports 1020. Through the network devices 1055, the computer 1005 may interact with a network 1060. Through the network 1060, the computer 1005 may be logically connected to remote computers 1065. Networks with which the computer 1005 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which one or more communication channels are established (or may be established upon request) that allow signals, data messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
accessing (1) a target entity and (2) a control framework that includes a plurality of controls, wherein the target entity and the plurality of controls are expressed in natural language;
embedding the target entity and the plurality of controls into a multidimensional space using a pre-trained embedding model;
quantifying similarities between the embedded target entity and the plurality of embedded controls;
providing the similarities as multivariate input to a regression model that is configured to generate relevancy probabilities that individual controls of the plurality of controls are relevant to the target entity;
applying a threshold for relevance to the relevancy probabilities to extract a listing of relevant controls that are most relevant to the target entity; and
generating an electronic alert that includes the listing of controls.

2. The computer-implemented method of claim 1, wherein the similarities are quantified based on similarities between titles and texts of the target entity and controls belonging to the plurality of controls.

3. The computer-implemented method of claim 2, wherein:
embedding the target entity and the plurality of controls into the multidimensional space further comprises generating separate embeddings for a title of the target entity, a text of the target entity, titles of the one or more controls, and texts of the one or more controls; and
quantifying the similarities between the embedded target entity and the one or more embedded controls further comprises, for the one or more controls, generating a vector of similarity scores that includes: (1) a first similarity score between the text of the control and the text of the target entity; (2) a second similarity score between the text of the control and the title of the target entity; (3) a third similarity score between the title of the control and the text of the target entity; and (4) a fourth similarity score between the title of the control and the title of the target entity.

4. The computer-implemented method of claim 1, further comprising:
accessing a second target entity expressed in the natural language;
embedding the second target entity into the multidimensional space using the pre-trained embedding model;
quantifying second similarities between the embedded second target entity and the plurality of embedded controls;
provide the second similarities as a second multivariate input to the regression model to generate second probabilities that the individual controls of the plurality of controls are relevant to the second target entity;
apply the threshold for relevance to the second probabilities to extract a second listing of relevant controls that are most relevant to the second target entity;
determine a set of mutual controls for the target entity and the second target entity that are in both the listing of relevant controls and the second listing of relevant controls; and
generate a chart that compares the relevance of the mutual controls to the target entity and the second target entity.

5. The computer-implemented method of claim 4, wherein the second target entity is a control belonging to a threat attack database.

6. The computer-implemented method of claim 1, wherein quantifying the similarities further comprises determining values of cosine similarity between the embedded target entity and the plurality of embedded controls.

7. The computer-implemented method of claim 1, wherein generating the electronic alert further comprises including a risk assessment of the target entity in the electronic alert.

8. One or more non-transitory computer-readable media that include stored thereon computer-executable instructions that when executed by at least a processor of a computing system cause the computing system to:
access (1) a target entity and (2) a control framework that includes a plurality of controls, wherein the target entity and the plurality of controls are expressed in natural language;
embed the target entity and the plurality of controls into a multidimensional space using a pre-trained embedding model;
quantify similarities between the embedded target entity and the plurality of embedded controls;
generate relevancy probabilities that individual controls of the plurality of controls are relevant to the target entity based on the similarities using a regression model;
apply a threshold for relevance to the relevancy probabilities to extract a listing of relevant controls that are most relevant to the target entity; and
generate an electronic alert that includes the listing of relevant security controls.

9. The one or more non-transitory computer-readable media of claim 8, wherein the instructions for quantifying the similarities further cause the computing system to:
determine a first similarity score between an embedded text of the control and an embedded text of the target entity;
determine a second similarity score between the embedded text of the control and an embedded title of the target entity;
determine a third similarity score between the embedded title of the control and the embedded text of the target entity; and
determine a fourth similarity score between the embedded title of the control and the embedded title of the target entity.

10. The one or more non-transitory computer-readable media of claim 9, wherein the similarity score is determined by cosine distance.

11. The one or more non-transitory computer-readable media of claim 8, wherein the instructions further cause the computing system to determine a set of mutual controls for the target entity and a second target entity.

12. The one or more non-transitory computer-readable media of claim 11, wherein the second target entity is a changed version of the target entity.

13. The one or more non-transitory computer-readable media of claim 11, wherein the target entity is a newly emerging cybersecurity threat and the second target entity is a software entity in a cloud tenancy, wherein the instructions further cause the computing system to, in real-time, identify the second target entity as being affected by the emerging cybersecurity threat based on the mutual controls.

14. The one or more non-transitory computer-readable media of claim 9, wherein the target entity is included in a second control framework, wherein the electronic alert includes a mapping of the control framework to the second control framework.

15. A computing system, comprising:
at least one processor connected to at least one memory;
one or more non-transitory computer-readable media that include stored thereon computer-executable instructions that when executed by at least a processor of the computing system cause the computing system to:
access (1) a target entity and (2) a control framework that includes a plurality of security controls, wherein the target entity and the plurality of security controls are expressed in natural language;
embed the target entity and the plurality of security controls into a multidimensional space using a pre-trained embedding model;
quantify similarities between the embedded target entity and the plurality of embedded security controls;
provide the similarities as multivariate input to a regression model that is configured to generate relevancy probabilities that individual security controls of the plurality of security controls are relevant to the target entity;
apply a threshold for relevance to the relevancy probabilities to extract a listing of relevant security controls that are most relevant to the target entity; and
generate an electronic alert that includes the listing of relevant security controls.

16. The computing system of claim 15, wherein the instructions for quantifying the similarities further cause the computing system to determine cosine distances between embeddings of one or more of the following pairs: (1) a text that describes the target entity and a text that describes the security control; (2) the text that describes the target entity and a title of the security control; (3) a title of the target entity and the text that describes the security control; and (4) the title of the target entity and the title of the security control.

17. The computing system of claim 15, wherein the instructions for generating the electronic alert further cause the computing system to:
detect a gap in coverage by the target entity;
indicate the gap in the electronic alert; and
in response to the electronic alert, automatically update the target entity to close the gap.

18. The computing system of claim 15, wherein the instructions for generating the electronic alert further cause the computing system to:
confirm coverage by the target entity; and
include the confirmation in the electronic alert.

19. The computing system of claim 15, wherein the pre-trained embedding model is a MiniLM model.

20. The computing system of claim 15, wherein the target entity is a description of an emerging cybersecurity threat, wherein the instructions further cause the computing system to:
automatically identify the listing of relevant security controls in real-time, wherein the relevant security controls are relevant to the emerging cybersecurity threat;
based on the relevant security controls, automatically identify one or more affected entities in the computing system to be affected by the emerging cybersecurity threat;
detect a gap between the relevant security controls and security controls applied to the affected entities in real-time;
include the gap in the electronic alert; and
in response to the electronic alert, automatically deploy configuration changes in the system to close the gap.
